(19) United States
(12) Patent Application Publication
(10) Pub. No.: US 2024/0352337 A1
(43) Pub. Date: Oct. 24, 2024

(54) NOVEL METHOD FOR REMOVING NITROGEN CONTAINING COMPOUNDS FROM A FEEDSTOCK

(71) Applicant: NESTE OYJ, Espoo (FI)

(72) Inventors: Pia BERGSTRÖM, Porvoo (FI); Ronny WAHLSTRÖM, Porvoo (FI); Sami ALAKURTTI, Porvoo (FI); Annika MALM, Porvoo (FI)

(73) Assignee: NESTE OYJ, Espoo (FI)

(21) Appl. No.: 18/684,266

(22) PCT Filed: Aug. 23, 2022
(86) PCT No.: PCT/EP2022/073391

§ 371 Date: Feb. 16, 2024

(30) Foreign Application Priority Data
Aug. 24, 2021 (FI) 20215884

(51) Int. Cl. C10G 3/00; C11B 3/00; C11B 3/04; C11B 3/10

(52) U.S. Cl. CPC C10G 3/40; C11B 3/001; C11B 3/04; C11B 3/10; C10G 2300/1014; C10G 2300/1018; C10G 2300/202; C10G 2300/205

(57) ABSTRACT

The present disclosure relates to a novel for removing or reducing nitrogen containing compounds from a feedstock.

### FIELD OF THE INVENTION

Present invention relates to the field of processing and purifying a feedstock. Specifically, the invention solves the problem of removing or reducing nitrogen containing compounds from a feedstock. The feedstock may be of any plant or animal origin and lipids therefrom. Present invention also relates to a purified feedstock obtainable by the method according to the invention.

### BACKGROUND OF THE INVENTION

In the art, methods are described in which various methods are used to purify feedstocks. For example, WO 2018/024728 relates to a phase separation methods for removing phosphorous compounds present in a feedstock which may comprise animal fats. Other compounds removed from the feedstock are metals like iron, magnesium and calcium or compounds containing such metals.

### SUMMARY OF THE INVENTION

As discussed herein, present invention relates to a method of removing or reducing nitrogen containing compounds from a feedstock.

Essentially, the method may comprise the steps of:
a) providing a feedstock comprising lipids of plant or animal origin,
b) adding an acid to the feedstock in a) together with an adsorbent, and optionally with addition of water,
c) heating the mixture obtained in step b),
d) separating the adsorbent from the mixture obtained c),
e) removing and/or neutralising the acid,
   to obtain a feedstock substantially free or nitrogen containing compounds or with a reduced amount nitrogen containing compounds.

In one aspect, present invention relates to removal or reduction of nitrogen containing compounds from a feedstock. The nitrogen containing compound could in principle be any compound, organic or inorganic compound, which comprises at least one nitrogen atom in its chemical formula. In one aspect, the nitrogen containing compound may be an amine or an amide.

In another aspect, the nitrogen containing compound that is removed or its amount reduced from the feedstock may by any nitrogen containing compound that is soluble in the feedstock or the feedstock matrix.

The feedstock may be of any plant or animal origin and may thus be based on any parts, derivatives or products based on any plants or animals, or any products originating from or based on algae or microbial oils.

The acid that may be used according to the invention may in principle be any acid. There are several non-limiting examples of this such as e.g. sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (Hl), or any combinations or mixtures thereof.

Other examples of acids that may be used is e.g. methyl sulfonic acid.

According to the invention, the adsorbent may in principle be any mineral-based adsorbent material. The mineral-based adsorbent material may be in any form e.g. as a solid e.g. powder, granules, beads, or mixed with a liquid e.g. suspension or as a gel. In one aspect, the adsorbent may be a silica based compound. The silica based compound may be any type of silica gel, which may be an amorphous and porous form of silicon dioxide (silica), consisting of an irregular tridimensional framework of alternating silicon and oxygen atoms with nanometer-scale voids and pores. The voids may contain water or some other liquids, or may be filled by gas or vacuum (also referred to as silica xerogel). In one aspect, any mineral-based adsorbent material may be used. In another aspect the adsorbent may be amorphous silica, preferably Trisyl.

According to the invention, the heating in the method (step c) may be in any range of e.g. about 60° C. to about 100° C., and preferably about 80° C.

According to the process, the adsorbent may be removed or separated from the mixture once the heating step has been considered concluded or completed. Removal or separation of the adsorbent may be effected by filtration, and/or centrifugation and/or sedimentation. In one aspect, removal of the adsorbent may be effected by decantation.

According to the invention, the process may include neutralization of the acid employed in the purification process. The process may alternatively comprise any other method for removing the acid used in the process. In yet another alternative, both a neutralization and other removal method may be employed. A non-limiting example may be washing the obtained feedstock with e.g. water or an aqueous solution. Neutralization may be performed by any known method in the art and may e.g. comprise addition of a suitable base/alkaline solution, such as e.g. addition of a NaOH solution.

The obtained purified feedstock may be essentially free of any nitrogen containing compound or may contain a reduced amount of nitrogen containing compounds. As mentioned herein, the purified feedstock may be essentially free of any nitrogen containing compound which is soluble in the feedstock or may contain a reduced amount of nitrogen containing compounds soluble in the feedstock. Such compounds may be e.g. amides or amide containing compounds or may be amine or amine containing compounds or any mixtures thereof. Thus, the purified feedstock may be 100% free of any nitrogen containing compounds, or may contain less than e.g. about 20% nitrogen containing compounds, or less than about 15%, less than about 10%, less than about 5%, less than about 3%, less than about 1%, less than about 0.5%, or less than about 0.1% nitrogen containing compounds measured as wt %.

As also mentioned herein, present invention relates to a purified feedstock obtainable by the method according to the invention.

### DEFINITIONS

By the term “feedstock” is intended to mean any material based on or originating from any plant or animal origin. It may also refer to any material based on algae or bacteria or fungal material. The term may also specifically comprise any plant oils, plant fats, animal fats and animal oils, and mold oils, selected from e.g. rapeseed oil, canola oil, colza oil, tall oil, sunflower oil, corn oil, technical/distillers corn oil, soybean oil, hemp oil, olive oil, linseed oil, cottonseed oil, mustard oil, palm oil, palm effluent sludge (PES), arachis oil, castor oil, coconut oil, animal fats such as e.g. suet, tallow, blubber, recycled alimentary fats, starting materials produced by genetic engineering, and biological starting materials produced by microbes such as algae, fungi and bacteria, yeast and the likes or any combinations or mixtures thereof.

The terminology “reduced” is intended to mean that a certain component is present in a lower amount in any material, such as e.g. a feedstock, in relation to its presence in any material prior to any processing or its presence in e.g. a feedstock used as a starting material or raw material in any process. A reduction may this be that one or more components are reduced by 100%, and thus is essentially completely removed, or reduced by at least about 30%, such as e.g. reduced by at least about 40%, such as e.g. reduced by at least about 50%, such as e.g. reduced by at least about 60%, such as e.g. reduced by at least about 70%, such as e.g. reduced by at least about 80%, such as e.g. reduced by at least about 85%, such as e.g. 90%, such as e.g. at least about 95%, such as e.g. at least about 97%, such as e.g. at least about 98%, such as e.g. at least about 99%. Such percentages may be measured as weight % (wt %) or volume % (vol %).

In one aspect, the reduction of nitrogen containing compounds is in range of about 40% to about 60%.

The terminology “acid” is intended to mean any Lewis acid or any chemical compound capable of donating a proton ion. The acid may be a mineral acid or a non-mineral acid such as e.g. sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (HI), or e.g. methyl sulfonic acid (CH₃SO₃H), or any combinations or mixtures thereof.

The terminology “silica based” compound is intended to mean any compound containing a silica atom. Such compounds may be silicon oxide based compounds such as e.g. silicone dioxide based compounds. Further examples are e.g. silicagels or silica xerogels in any form or configuration. Further non-limiting example is e.g. silica alumina gel. Several varieties of silica based compounds exist on the market such as e.g. Trisyl® etc. which are also included in the terminology.

### DETAILED DESCRIPTION OF THE INVENTION

As mentioned above, present invention relates to a method of removing or reducing nitrogen containing compounds from a feedstock.

Present invention provides for a method enabling use of a feedstock for the preparation of other raw materials such as e.g. fuels and fine chemicals whereby unwanted nitrogen containing compounds are essentially removed or reduced in the purified feedstock. Present invention thus provides for a simple and effective processing of a feedstock for removal of nitrogen containing compounds and thus presents a method for use of renewable raw material. The inventors of present invention have surprisingly discovered that e.g. a particularly efficient removal of nitrogen containing compounds and/or phosphorous containing compounds and/or metal containing compounds, may be observed when the adsorbent is added together with the acid in the process. This is merely one of the many beneficial features of present invention, the contents of which will be discussed in detail below.

Moreover, the method of present invention allows for large scale industrial production of a purified feedstock from renewable sources.

In one aspect, the method according to the invention may comprise the steps of:
a) providing a feedstock comprising lipids of plant or animal origin,
b) adding an acid to the feedstock in a) together with an adsorbent, and optionally with addition of water,
c) heating the mixture obtained in step b),
d) separating the adsorbent from the mixture obtained in step c),
e) removing and/or neutralising the acid,
   to obtain a feedstock substantially free or nitrogen containing compounds or with a reduced amount nitrogen containing compounds.

In a further aspect, present invention may relate to a method comprising or consisting of the steps of;
a) providing a feedstock comprising lipids of plant or animal origin,
b) adding an acid in an amount of about 0.5 wt % to about 5 wt % to the feedstock in a) together with an amorphous silica adsorbent in an amount of about 0.5 wt % to about 5 wt %, and optionally with addition of water in an amount of about 1 wt % to about 5 wt %,
c) heating the mixture obtained in step b) to a temperature in range of about 30° C. to about 200° C. during a period of about 5 min to about 6 h,
d) separating the adsorbent from the mixture obtained c),
e) removing and/or neutralising the acid,
   to obtain a feedstock substantially free of nitrogen containing compounds or with a reduced amount of nitrogen containing compounds, wherein the nitrogen containing compounds are compounds soluble in the feedstock or feedstock matrix.

In one aspect, step e) takes place after step d).

In one aspect, the method according to the invention may be executed in sequence, i.e. beginning with step a) which is followed by step b), and subsequently followed by step c), and step d) and finally step e).

In yet a further aspect, the method according to the invention does not comprise any steps or reaction conditions in between one or more of the steps a)-b)-c)-d), or -e).

The feedstock according to the invention may in principle be any material based on or originating from any plant or animal origin. Thus, the feedstock according to the invention may be a feedstock used as a starting or raw material for the further production of any type of fuel or fuel component and may this serves as a raw material/starting material for the production of renewable fuel. The feedstock may also be a feedstock for the production of any type of fine chemicals. Thus, the feedstock may be also be based on any algae or bacteria or fungal material. Non-limiting examples may be any plant oils, plant fats, animal fats and animal oils, and mold oils, selected from e.g. rapeseed oil, canola oil, colza oil, tall oil, sunflower oil, corn oil, technical/distillers corn oil, soybean oil, hemp oil, olive oil, linseed oil, cottonseed oil, mustard oil, palm oil, palm effluent sludge (PES), arachis oil, castor oil, coconut oil, animal fats such as e.g. suet, tallow, blubber, recycled alimentary fats, used cooking oil, starting materials produced by genetic engineering, and biological starting materials produced by microbes such as algae and bacteria and the likes or any combinations or mixtures thereof.

According to the process, once the feedstock has been provided, said feedstock is mixed or contacted with an acid or acidic compound (which may be in step b) of the process). According to the invention, the acid may in principle be any Lewis acid or compound capable of donating or liberating a hydrogen ion. Non-limiting examples are e.g. any type of mineral acid, such as e.g. sulphuric acid (H₂SO₄), hydrochloric acid (HCl), nitric acid (HNO₃), phosphoric acid (H₃PO₄), boric acid (H₃BO₃), hydrofluoric acid (HF), hydrobromic acid (HBr), perchloric acid (HClO₄), or hydroiodic acid (Hl), or any mixtures thereof.

In one aspect, the mineral acid may be sulphuric acid (H₂SO₄).

However, the acid according to the invention may also be any other acid, other than a mineral acid, such as e.g. any type of organic acid. Further non-limiting examples may be e.g. methyl sulfonic acid (CH₃SO₃H) or ethyl sulphonic acid (CH₃CH₂SO₃H).

In one aspect, the acid may be methyl sulfonic acid (CH₃SO₃H).

In one aspect, the acid is added in an amount of about 0.5 wt % to about 5 wt %, preferably about 1 wt % or about 2 wt %, based on the content of the weight of the feedstock.

According to the process, the acid added to the feedstock may in principle be in any concentration, such as e.g. about at least about 60 vol %, such as e.g. at least about 70 vol %, such as e.g. at least about 80 vol %, such as e.g. at least about 85 vol %, such as e.g. at least about 90 vol %, such as e.g. at least about 95 vol %, such as e.g. at least about 96 vol %, such as e.g. at least about 97 vol %, such as e.g. at least about 98 vol %, or such as e.g. at least about 99 vol %, or such as e.g. at least about 99.5 vol %. The acid may be provided as an aqueous solution in the given concentrations.

The acid may be mixed or contacted with the feedstock by mechanical stirring or agitation. In another aspect, high shear mixing may be employed.

The adsorbent is added to the process step b). The addition must provide for a contact between the adsorbent and the acid/feedstock mixture. Contacting or mixing may be effected by mechanical stirring or agitation, or high shear mixing. The purpose of the adsorbent is to adsorb water soluble nitrogen compounds from the acid/feedstock mixture.

Optionally, the acid is added to the feedstock to enable sufficient mixing or contact with the feedstock, and mixed during a period of between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute prior to addition and mixing in with the adsorbent.

In one aspect, once the acid is added to the feedstock, the mixing or agitation takes place for a period of about 5 minutes prior to addition of the silicon based compound.

Optionally, the acid/feedstock mixture is heated to a temperature above ambient temperature, such as e.g. between about 30° C. to about 200° C., such as e.g. about 40° C., such as e.g. about 50° C., such as e.g. about 60° C., such as e.g. about 70° C., such as e.g. about 80° C., such as e.g. about 90° C., such as e.g. about 100° C., such as e.g. about 110° C., such as e.g. about 130° C., such as e.g. about 150° C., such as e.g. about 170° C., such as e.g. about 200° C.

In one aspect, the acid/feedstock mixture is heated to a temperature of about 80° C. prior to addition of the adsorbent.

In a further aspect, optionally, the mixing of the acid/feedstock may take place by heating the acid/feedstock at any temperature above ambient temperature, such as e.g. between about 30° C. to about 200° C., such as e.g. about 40° C., such as e.g. about 50° C., such as e.g. about 60° C., such as e.g. about 70° C., such as e.g. about 80° C., such as e.g. about 90° C., such as e.g. about 100° C., such as e.g. about 110° C., such as e.g. about 130° C., such as e.g. about 150° C., such as e.g. about 170° C., such as e.g. about 200° C., for a period of between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute prior to addition and mixing in with the adsorbent.

Thus in one aspect, the acid/feedstock mixture is heated to about 80° C. for about 5 min prior to addition of the adsorbent.

In one aspect, the acid and the adsorbent are essentially added simultaneously to the feedstock and mechanically mixed or agitated together with the feedstock. Such mixing or agitation may take place during a period of between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute.

The adsorbent may in principle be any mineral-based compound preferable a silica based compound. The silica based compound may in principle be any silicon oxide based compounds such as e.g. silicone dioxide based compounds. Further non-limiting examples are e.g. silicagels or silica xerogels in any form or configuration. Further non-limiting example according to the invention is e.g. silica alumina gel. Several varieties of silica based compounds exist on the market such as e.g. Trisyl® etc. which are also encompassed by present invention.

The adsorbent may be added in an amount of 0.5 wt % to about 5 wt %, preferably about 1 wt % or about 2 wt %, based on the content of the weight of the feedstock.

The process according to the invention may optionally comprise addition of water in step b), or in other words: in some aspects the invention may comprise the addition of water, or may in other aspects not comprise any addition of water in step b). The amount of added water in step b) is in an amount of about 1 wt % to about 5 wt %, and preferably about 2 wt % based on the weight of the feedstock.

According to the invention, the process in step c), comprises a heating step. Heating may be at any temperature above ambient temperature, such as e.g. in the range of in the range of about 30° C. to about 200° C., such as e.g. in the range of in the range of about 35° C. to about 150° C., such as e.g. in the range of in the range of about 40° C. to about 130° C., such as e.g. in the range of in the range of about 50° C. to about 120° C., such as e.g. in the range of in the range of about 60° C. to about 100° C., such as e.g. in the range of in the range of about 70° C. to about 90° C., or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In one aspect, the heating in step c) may be in any temperature interval of about 60° C. to about 100° C. In one aspect, the heating in step c) may be preferably about 80° C.

The heating in step c) may be conducted for any period of about 5 min to about 90 minutes, preferably about 20 min or about 60 min. Or alternatively for up to about 6 h, such as e.g. up to about 5 h, such as e.g. up to about 4 h, such as e.g. up to about 3 h, such as e.g. up to about 2 h, such as e.g. up to about 90 minutes, such as e.g. up to about 80 minutes, such as e.g. up to about 70 minutes, such as e.g. up to about 60 minutes, such as e.g. up to about 50 minutes, such as e.g. up to about 40 minutes, such as e.g. up to about 30 minutes, such as e.g. up to about 20 minutes, such as e.g. up to about 10 minutes, such as e.g. up to about 5 minutes.

The heating step c) may be conducted under reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar.

The drying step optionally following step c) may comprise treating the mixture resulting from step c) at an elevated temperature. Such temperature may be any temperature above ambient temperature, such as e.g. in the range of in the range of about 30° C. to about 200° C., such as e.g. in the range of in the range of about 35° C. to about 150° C., such as e.g. in the range of in the range of about 40° C. to about 130° C., such as e.g. in the range of in the range of about 50° C. to about 120° C., such as e.g. in the range of in the range of about 60° C. to about 100° C., such as e.g. in the range of in the range of about 70° C. to about 90° C., or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C.

In one aspect, the drying step may comprise treatment at a temperature of about 90° C. to about 110° C., preferably about 105° C.

The drying step optionally following step c) may also comprise treatment of the mixture and at reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar, or alternatively at least at 90 mbar, such as e.g. at least 80 mbar, such as e.g. at least 70 mbar, such as e.g. at least 60 mbar, such as e.g. at least 50 mbar, such as e.g. at least 40 mbar, such as e.g. at least 30 mbar, such as e.g. at least 20 mbar, such as e.g. at least 10 mbar, such as e.g. at least 5 mbar, such as e.g. at least 1 mbar.

In one aspect, the reduced pressure may be about 50 mbar to about 100 mbar, or preferably about 80 mbar.

The drying step optionally following step c) may be conducted for any suitable period of time or until deemed sufficient to remove a desired amount of water or until the amount of water left in the mixture is deemed acceptable. Such period of time may be for a time period of about 5 min to about 90 minutes, preferably about 20 min or about 60 min. Or alternatively for up to about 6 h, such as e.g. up to about 5 h, such as e.g. up to about 4 h, such as e.g. up to about 3 h, such as e.g. up to about 2 h, such as e.g. up to about 90 minutes, such as e.g. up to about 80 minutes, such as e.g. up to about 70 minutes, such as e.g. up to about 60 minutes, such as e.g. up to about 50 minutes, such as e.g. up to about 40 minutes, such as e.g. up to about 30 minutes, such as e.g. up to about 20 minutes, such as e.g. up to about 10 minutes, such as e.g. up to about 5 minutes.

In one aspect, the period of time may be during any time period of about 5 min to about 60 min, or preferably about 15 min or about 45 min.

Thus, according to one aspect, the invention may relate to a method comprising treating the feedstock with an acid in an amount of about 1 wt % to about 2 wt % (relative to weight of feedstock) together with an adsorbent in an amount of about 2 wt % to about 4 wt % (relative to weight of feedstock), and optionally with addition of water in an amount of about 2 wt % to about 4 wt % (relative to weight of feedstock) and heating the resulting mixture at about 80° C. for a period from about 20 min to about 60 min at a reduced pressure of about 800 mbar. This may optionally be followed by heating the mixture at about 105° C. during a period of about 15 min to about 45 min at a reduced pressure of about 80 mbar.

According to the invention, the adsorbent may be removed by any suitable method known in the art. In one aspect, the adsorbent is removed in step d), and thus separating the adsorbent from the mixture obtained c).

Separation of the adsorbent may be conducted by filtration, sedimentation/settling, centrifugation, or decantation or any combinations thereof. Optionally, the removal of the adsorbent may be performed under vacuum or reduced pressure such as e.g. a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar, or alternatively at least at 90 mbar, such as e.g. at least 80 mbar, such as e.g. at least 70 mbar, such as e.g. at least 60 mbar, such as e.g. at least 50 mbar, such as e.g. at least 40 mbar, such as e.g. at least 30 mbar, such as e.g. at least 20 mbar, such as e.g. at least 10 mbar, such as e.g. at least 5 mbar, such as e.g. at least 1 mbar.

The acid added to the process may be removed from the treated mixture by any suitable means. According to the invention, the acid may be removed from the process in step e). In one aspect, the acid is removed by neutralization by addition of a basic/alkaline compound of solution. In another aspect, the acid is removed by washing the mixture with e.g. water or a suitable aqueous solution. In yet a further aspect, the acid is removed by both neutralization and washing.

The neutralizing agent may in principle be any suitable base, such as e.g. NaOH, KOH, Ca(OH)₂ etc. or an aqueous solution thereof. The aqueous solution may in principle have any concentration of the basic/alkaline compound to such an extent that the final water content does not result in an excessive amount of water to be removed further on in any following process.

The concentration may be e.g. about 50 wt % or more, such as e.g. 60 wt % or more, such as e.g. 70 wt % or more, such as e.g. 80 wt % or more, etc.

According to the invention, the amount of nitrogen containing compounds soluble in the feedstock or feedstock matrix may be reduced by at least about 20 wt %, such as e.g. about 30 wt %, such as e.g. about 40 wt %, such as e.g. about 50 wt %, such as e.g. about 60 wt %, such as e.g. about 70 wt %, such as e.g. about 80 wt %, such as e.g. about 90 wt %, such as e.g. about 95 wt %, such as e.g. about 98 wt %, or at least essentially free of any nitrogen containing compounds soluble in the feedstock or feedstock matrix in relation to the nitrogen containing compounds present in the feedstock prior to the processing according to the method according to the invention. In one aspect, the nitrogen containing compounds may be amines and/or amides (such as e.g. phosphor amides) or any salts thereof.

According to the invention, the method also enables reduction of phosphorous or phosphorous containing compounds, and/or any metals present in the feedstock prior to the processing/method according to the invention. According to one aspect of the invention, the amount of phosphor or phosphorous containing compounds and metals are removed by at least about 80%, such as e.g. at about least 85%, such as e.g. at least about 90%, such as e.g. about at least about 95%, such as e.g. at least 98% or e.g. at least 99% or more.

In one aspect, present invention also relates to a feedstock obtainable by the method/process according to the invention.

Consequently, present invention relates to a purified feedstock wherein the amount of phosphorous containing compounds amounts to less than 5 ppm, such as e.g. less than 4 ppm, less than e.g. 3 ppm, less than 2 ppm, or less than 1 ppm.

In a further aspect, present invention relates to a purified feedstock wherein the amount of nitrogen containing compounds, which may include primary amides, in an amount of less than about 900 ppm or less, such as e.g. about 800 ppm or less, such as e.g. about 700 ppm or less, such as e.g. about 600 ppm or less, such as e.g. about 500 ppm or less, such as e.g. about 250 ppm or less, such as e.g. about 100 ppm or less, such as e.g. about 50 ppm or less, such as e.g. about 30 ppm or less, such as e.g. about 10 ppm or less, such as e.g. about 5 ppm or less. In one aspect, the content of primary amides may be about 1.0 wt % or less (based on the weight of the purified feedstock), such as e.g. about 0.8 wt % or less, such as e.g. about 0.6 wt % or less, such as e.g. about 0.4 wt % or less, such as e.g. about 0.3 wt % or less, such as e.g. about 0.2 wt % or less, such as e.g. about 0.1 wt % or less.

In a further aspect, the metal content of the purified feedstock may be less than about 20 ppm or less, such as e.g. about 15 ppm or less, such as e.g. about 10 ppm or less, such as e.g. about 5 ppm or less, such as e.g. about 1 ppm or less.

Present invention also relates to use of a feedstock obtainable by the method according to the invention, for any type of fuel preparation or for use in preparation of fine chemicals. Consequently, the method according to the invention provides for a purified feedstock resulting from the method, wherein the feedstock fulfils various requirements for further processing into e.g. fuels. Such requirements may e.g. be impurity levels low enough to permit catalytic reactions of any kind, and thus not contributing to poisoning of catalysts or hampering other reaction conditions.

### EXAMPLES

In the following, the invention is illustrated by the following non-limiting example.

### Example 1

Heating animal fat feedstock with conc. H₂SO₄ (e.g. 1 or 2 wt-%) either with or without a small water addition (e.g. 2 or 4 wt-%) for a set time will lead to a reduction of P, metals, total N-containing compounds and amides. The acid excess is washed away with water extraction or neutralized by base.

A particularly effective treatment was found when Trisyl silica was added to the acid treatment, as illustrated in the following example:

Low quality animal fat (P=70 ppm, metals sum Si, K, Mg, Ca, Al, Zn, Fe, Co=344 ppm) was treated with sulphuric acid (2 wt-%), water (4 wt-%) and silica (Trisyl, 4 wt-%) under extended time under the following conditions (60 min, 80° C., 800 mbar, then 45 min, 105° C., 80 mbar). Trisyl was removed by filtration under vacuum. Oil was washed with aqueous NaOH (50 w-%) to neutralise excess sulphuric acid.

New treatment removed 95% of P (70.3 to 3.7 ppm) and 97% of metals (344 to 10.6 ppm). In addition, total N content and primary amides in bleached oil were reduced by 60% (total N from 1670 to 715 ppm and p-amides from 0.86 to 0.36 wt-%).

### Example 2

Heating the lipid feed with conc. H₂SO₄ (e.g. 1 or 2 wt-%) either with or without a small water addition (e.g. 2 wt-%) for a set time will lead to a reduction of its N concentration and as measured part of the removed N is in the form of primary amides. The acid excess need to be washed away or neutralized by base.

A particularly effective treatment was found when Trisyl silica was added to the acid treatment:

Tallow fatty acid distillate (TFAD) was mixed with sulfuric acid (1 wt %), water (2 wt-%) and an amorphous silica like e.g. Trisyl 3000 silica (2 wt-%) were added at 80° C. Reaction mixture was stirred at 80° C., 800 mbar for 20 min; and at 105° C., 80 mbar for 15 min. Silica was removed by filtration and oil phase was washed with water to remove residual acid and phases were separated by centrifugation. A decrease in the feeds N content from 1940 to 795 mg/kg (−59%), and primary amide content from 1.09 to 0.65 wt-% (−40%), were measured after the treatment.

### Example 3

Heating the PES (Palm Effluent Sludge) feed with conc. H₂SO₄ (e.g. 1 wt-%) either with or without a small water addition (e.g. 2 or 4 wt-%) for a set time will lead to a reduction of P, metals and total N. The acid excess need to be washed away or neutralized by base.

A particularly effective treatment was found when an amorphous silica based compound like e.g. Trisyl silica was added to the acid treatment:

PES N=90.4 ppm, P=26.0 ppm and total metals=241.4 ppm was treated with sulphuric acid (1 wt-%) and amorphous silica (2 wt-%) under extended time under the following conditions (60 min, 80° C., 800 mbar+45 min, 105° C., 80 mbar). Trisyl was removed by filtration under vacuum. Oil was washed with aqueous NaOH (50 w-% aq solution) to neutralise excess sulphuric acid. pH of water phase after washing was 4.3, thus there was no need for further water washings to remove excess acid.

Strong acid treatment removed P 94% (26 to 1.5 ppm), metals 98% (241.4 to 4.1 ppm, excluding Na residues from neutralisation step and N 66% (90.4 to 30.8 ppm). Noteworthy, difficult to bleach iron and calcium were reduced to 1 ppm or less each.

1.-20. (canceled)

21. A method for removing or reducing nitrogen containing compounds, including amides, from a feedstock from renewable sources, the method comprising;
a) providing a feedstock including lipids of plant or animal origin;
b) adding an acid to the feedstock in a) together with an adsorbent, and optionally with addition of water, to form a mixture wherein the acid contains one or more of sulphuric acid (H2SO4), hydr°Chloric acid (HCl), nitric acid (HNO3), phosphoric acid (H3PO4), boric acid (H3BO3), hydrofluoric acid (HF), hydrobromic acid (HBr), perchloric acid (HClO4), or hydroiodic acid (HI), methyl sulfonic acid or ethyl sulfonic acid, or any combinations thereof;
c) heating the mixture obtained in step b);
d) separating the adsorbent from the mixture obtained c); and
e) removing and/or neutralising the acid;
to obtain a feedstock substantially free of nitrogen containing compounds, including amides, or with a reduced amount of nitrogen containing compounds, including amides, wherein the nitrogen containing compounds are compounds soluble in the feedstock or feedstock matrix.

22. The method according to claim 21, wherein the feedstock is plant oils, plant fats, animal fats and animal oils, and mold oils, selected from corn oil/technical/distillers corn oil, rapeseed oil, canola oil, colza oil, tall oil, sunflower oil, soybean oil, hemp oil, olive oil, linseed oil, cottonseed oil, mustard oil, palm oil, palm effluent sludge (PES), arachis oil, castor oil, Coconut oil, animal fats, suet, tallow, blubber, recycled alimentary fats, starting materials produced by genetic engineering, and biological starting materials produced by microbes, algae and bacteria or any combinations thereof.

23. The method according to claim 21, wherein the adsorbent is an amorphous silica adsorbent, any mineral based adsorbent material, silica gel or silica xerogel in any configuration, or any mineral based adsorbent.

24. The method according to claim 21, wherein the heating in step c) is conducted above ambient temperature, in a range of about 30° C. to about 200° C., including but not limited to, in a range of about 35° C. to about 150° C., in a range of about 40° C. to about 130° C., in a range of about 50° C. to about 120° C., in a range of about 60° C. to about 100° C., in a range of about 70° C. to about 90° C., or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., and/or about 200° C.

25. The method according to claim 21, wherein the heating in step c) occurs during a period of about 5 min to about 90 minutes, and/or about 20 min or about 60 min, or alternatively for up to about 6 h, including but not limited to, up to about 5 h, up to about 4 h, up to about 3 h, up to about 2 h, up to about 90 minutes, up to about 80 minutes, up to about 70 minutes, up to about 60 minutes, up to about 50 minutes, up to about 40 minutes, up to about 30 minutes, up to about 20 minutes, up to about 10 minutes, and/or up to about 5 minutes.

26. The method according to claim 21, comprising:
conducting the heating in step c) under reduced pressure under normal pressure (1 atm, standard atmospheric pressure corresponding to 1013.25 mbar), including but not limited to at a pressure of about 100 mbar to about 900 mbar, about 200 mbar to about 900 mbar, about 300 mbar to about 900 mbar, about 400 mbar to about 900 mbar, about 500 mbar to about 900 mbar, about 600 mbar to about 900 mbar, about 700 mbar to about 900 mbar, and/or about 800 mbar.

27. The method according to claim 21, wherein step c) is optionally followed by a drying step, the drying step comprising one or more of;
i) applying temperatures above ambient temperature, in a range of about 30° C. to about 200° C., including but not limited to, in a range of about 35° C. to about 150° C., in a range of about 40° C. to about 130° C., in a range of about 50° C. to about 120° C., in a range of about 60° C. to about 100° C., in a range of about 70° C. to about 90° C., and/or about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., or about 200° C., or alternatively heating temperatures of about 90° C. to about 110° C., and/or about 105° C.;
ii) applying reduced pressure under normal pressure (1 atm, standard atmospheric pressure corresponding to 1013.25 mbar), including, but not limited to, at a pressure of about 100 mbar to about 900 mbar, about 200 mbar to about 900 mbar, about 300 mbar to about 900 mbar, about 400 mbar to about 900 mbar, about 500 mbar to about 900 mbar, about 600 mbar to about 900 mbar, about 700 mbar to about 900 mbar, and/or about 800 mbar, or alternatively at least at 90 mbar, including but not limited to, at least 80 mbar, at least 70 mbar, at least 60 mbar, at least 50 mbar, at least 40 mbar, at least 30 mbar, at least 20 mbar, at least 10 mbar, at least 5 mbar, at least 1 mbar, and/or alternatively about 50 mbar to about 100 mbar, and/or about 80 mbar; and/or
iii) wherein a duration of the drying step is for a time period of 5 min to about 90 minutes, and/or about 20 min or about 60 min, and/or for up to about 6 h, including but not limited to, up to about 5 h, up to about 4 h, up to about 3 h, up to about 2 h, up to about 90 minutes, up to about 80 minutes, up to about 70 minutes, up to about 60 minutes, up to about 50 minutes, up to about 40 minutes, up to about 30 minutes, up to about 20 minutes, up to about 10 minutes, and/or up to about 5 minutes.

28. The method according to claim 21, wherein the acid is added in an amount of about 0.5 wt % to about 5 wt %, and/or about 1 wt % or about 2 wt %, based on a content of a weight of the feedstock.

29. The method according to claim 21, wherein the adsorbent is added in an amount of 0.5 wt % to about 5 wt %, and/or about 1 wt % or about 2 wt %, based on a content of a weight of the feedstock.

30. The method according to claim 21, wherein the water optionally added in step b) is in an amount of about 1 wt % to about 5 wt %, and/or 2 wt %.

31. The method according to claim 21, comprising:
removing the adsorbent by filtration, centrifugation, settling or any combination thereof and optionally under vacuum or reduced pressure.

32. The method according to claim 21, comprising:
removing the acid by water washing and/or neutralization by addition of a suitable base or a solution thereof, NaOH, KOH, and/or Ca(OH)2.

33. The method according to claim 21, comprising:
reducing the amount of nitrogen containing compounds soluble in the feedstock or feedstock matrix by at least about 20 wt %, including but not limited to, about 30 wt %, about 40 wt %, about 50 wt %, about 60 wt %, about 70 wt %, about 80 wt %, about 90 wt %, about 95 wt %, about 98 wt %, and/or at least essentially free of any nitrogen containing compounds soluble in the feedstock or feedstock matrix in relation to the nitrogen containing compounds present in the feedstock prior to processing according to the method.

34. The method according to claim 21, wherein the amount of phosphorous and metals are removed by at least 95%, including but not limited to, at least 98% and/or at least 99% or more.

35. A feedstock obtainable by the purification method according to claim 21.

36. The method according to claim 21, comprising:
preparing a fuel or a fine chemical with the feedstock substantially free of nitrogen containing compounds.

37. A feedstock comprising;
a) phosphorous containing compounds in an amount of about 5 ppm, and/or less than 4 ppm, less than e.g. 3 ppm, less than 2 ppm, and/or less than 1 ppm;
b) metal containing compounds in an amount of about 20 ppm or less, and/or about 15 ppm or less, and/or about 10 ppm or less, and/or about 5 ppm or less, and/or about 1 ppm or less; and
c) nitrogen containing compounds in an amount of about 900 ppm or less, and/or about 800 ppm or less, and/or about 700 ppm or less, and/or about 600 ppm or less, and/or about 500 ppm or less, and/or about 250 ppm or less, and/or about 100 ppm or less, and/or about 50 ppm or less, and/or about 30 ppm or less, and/or about 10 ppm or less, and/or about 5 ppm or less.

38. The feedstock according to claim 37, wherein a content of primary amides is about 1.0 wt % or less (based on the weight of the purified feedstock), and/or about 0.8 wt % or less, and/or about 0.6 wt % or less, and/or about 0.4 wt % or less, and/or about 0.3 wt % or less, and/or about 0.2 wt % or less, and/or about 0.1 wt % or less.
